(19) United States
(12) Patent Application Publication
(10) Pub. No.: US 2025/0147987 A1
(43) Pub. Date: May 8, 2025

(54) DATABASE RECORD CREATION FROM TEXT-BASED INTERACTIONS

(71) Applicant: Salesforce, Inc., San Francisco, CA (US)

(72) Inventors: Feifei JIANG, San Francisco, CA (US); Regunathan RADHAKRISHNAN, Dublin, CA (US); Zachary ALEXANDER, Berkeley, CA (US); Xiangbo MAO, Vancouver (CA); Sefi ERLICH, Tel Aviv (IL); Shai BAR-SHALOM, Tel Aviv (IL); Wala GOANMI, Tel Aviv (IL); Sitaram ASUR, Fremont, CA (US); Tomer Parash MAPA, Tel Aviv (IL); Sameer ABHINKAR, San Francisco, CA (US)

(73) Assignee: Salesforce, Inc., San Francisco, CA (US)

(21) Appl. No.: 18/502,325

(22) Filed: Nov. 6, 2023

(51) Int. Cl. G06F 16/31; G06F 16/33

(52) U.S. Cl. CPC G06F 16/31; G06F 16/3347

(57) ABSTRACT

A text interaction record is received at a database system. The text interaction record may include interaction text from one or more messages between a client machine and a service provider. An input database record creation prompt that includes natural language instructions to generate database record field text based on the text interaction record may be determined. The input database record creation prompt may include some or all of the interaction text. The input database record creation prompt may be transmitted to a large language model for completion. A completed database record creation prompt may be received from the large language model. The completed database record creation prompt may include a text element created by the large language model based on the input database record creation prompt. A database record including a database field storing the text element may be generated in the database system.

### FIELD OF TECHNOLOGY

This patent application relates generally to database systems, and more specifically to techniques for identifying, accessing, updating, and creating text-based database records.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks. One example of such a cloud computing service is a database system that stores data for a variety of users and is accessible via the internet.

Database systems store increasingly large amounts of text-related information. For instance, a database storing customer relations management (CRM) information may store many records reflecting interactions between customer service agents and customers. Such information is useful, for instance as examples when generating novel text in the course of new customer interactions. However, existing search and retrieval techniques for identifying, accessing, updating, and creating text-based information stored in database systems are limited. Accordingly, improved techniques for searching, querying, updating, and generating database system text records are desired.

### BRIEF DESCRIPTION OF THE DRAWINGS

The included drawings are for illustrative purposes and serve only to provide examples of possible structures and operations for the disclosed inventive systems, apparatus, methods, and computer program products for text generation based on database records. These drawings in no way limit any changes in form and detail that may be made by one skilled in the art without departing from the spirit and scope of the disclosed implementations.

FIG. 1 illustrates an overview method for generating text, performed in accordance with one or more embodiments.

FIG. 2 illustrates a database system, configured in accordance with one or more embodiments.

FIG. 3 illustrates a method for pre-processing text interactions, performed in accordance with one or more embodiments.

FIG. 4 illustrates a method for determining a text record type configuration, performed in accordance with one or more embodiments.

FIG. 5 illustrates a method for determining an input text field generation prompt, performed in accordance with one or more embodiments.

FIG. 6 illustrates a method for retrieving one or more text interactions, performed in accordance with one or more embodiments.

FIG. 7 illustrates a method for generating a text record, performed in accordance with one or more embodiments.

FIG. 8 shows a block diagram of an example of an environment that includes an on-demand database service configured in accordance with some implementations.

FIG. 9A shows a system diagram of an example of architectural components of an on-demand database service environment, configured in accordance with some implementations.

FIG. 9B shows a system diagram further illustrating an example of architectural components of an on-demand database service environment, in accordance with some implementations.

FIG. 10 illustrates one example of a computing device, configured in accordance with one or more embodiments.

### DETAILED DESCRIPTION

Techniques and mechanisms described herein provide for the automated and assisted generation of database system text records based on text interactions. For instance, a text interaction between a human agent and a remote individual such as a customer may be used to query the database system for related interaction records and/or text records, which may be used to guide the human agent in interacting with the remote user. If a suitable text record is not found, then a new text record may be created or an existing text record may be updated based at least in part on the text interaction. For instance, a prompt may be generated based on a record type. The prompt may include instructions to a large language model to generate text for one or more fields to include in a text record stored in the database system. The text record may then be stored for retrieval, for instance to aid in subsequent interactions between human agents and remote users.

In some embodiments, a database system may include a type of database record referred to herein as a “text record”. A text record may be used for any of a variety of purposes. For instance, a text record may be used to store knowledge to aid human agents in interacting with remote users, for example in a service context. A text record may store, for instance, information useful to a human agent when addressing a particular type of customer concern. Thus, a collection of text records may serve as a knowledge base, for instance to support a cloud-based customer service environment, with one or more individual text records serving as a knowledge base article that includes information useful to a customer service agent.

In the customer service context, since both agents and customers rely on the knowledge stored in a knowledge base for answers and guidance on customer issues, keeping the knowledge base up to date is important. However, when using conventional techniques, generating and updating knowledge base articles is a time-consuming and manual process. Conventional approaches provide no reliable way to track or bridge the gap between customer concerns and the knowledge available to address those concerns. As a result, when using conventional techniques, maintaining a knowledge base requires authors and managers to manually identify gaps and manually generate knowledge articles. In contrast to conventional techniques, techniques and mechanisms described herein provide for machine-aided knowledge gap detection and knowledge article writing.

Consider the following example from the customer service context, provided in accordance with one or more embodiments. After a customer case or conversation is created reflecting an interaction between a service agent and a customer, the system may first display one or more existing knowledge articles that are relevant to the customer issue and may provide useful solution or guidance. Then the service agent may then review the recommended knowledge articles and decide if they are useful for addressing the issue. By first displaying to the agent existing knowledge articles that are relevant to the conversation, the system may avoid creating duplicate knowledge articles, instead creating them when they are needed.

Continuing the example, if the recommended articles are insufficiently useful, in some embodiments the service agent may generate an article with assistance from the system. For instance, the service agent may choose a predetermined article type and/or can manually select one or more fields to include in the knowledge article (e.g., technical problem, resolution, root cause, troubleshooting steps).

Continuing the example, in some embodiments a large language model may then generate suggested text for the fields based on the conversation. To facilitate the text generation, a base prompt containing instructions for generating different text elements may be generated. The base prompt may then incorporate specific text fields (e.g., those included in a predetermined article type and/or those selected by the service agent) along with their descriptions to produce a final prompt. The final prompt is sent to the LLM model to produce suggested text to include in the knowledge article. The text may then be refined (e.g., by the service agent) and then stored as one or more records in the database system.

According to various embodiments, a base prompt may be used to flexibly facilitate the creation of different types of knowledge records (e.g., frequently asked questions, troubleshooting articles, tutorial articles). Final prompts may be dynamically created with instructions for the relevant fields being selected to create the final prompt. For instance, the prompt for an FAQ article may include instructions for Questions and Answers and may omit instructions for other types of fields, with the prompt being dynamically composed based on a FAQ article record type predetermined by an administrator.

In some embodiments, service agents may select knowledge fields and generate specific knowledge elements from the conversation based on these fields. Also, the language model may be instructed to provide supporting elements for generated text, which may allow the service agent to review the generated text against the supporting evidence for accuracy.

In some implementations, different knowledge articles may be generated in accordance with different styles or tones. Such styles or tones may be predetermined and stored in configuration information associated with a knowledge article type. Alternatively, or additionally, style or tone information may be selected by the service agent. Examples of styles or tones may include, but are not limited to: expert tone/style, layman tone/style, and FAQ tone/style.

Consider the example of Alexandra, a customer service agent employing a cloud-based customer service environment to help her address a customer's concerns, for instance during an email exchange or a real-time conversation conducted via voice or chat. Alexandra may search a knowledge base accessible via the cloud-based customer service environment in an attempt to identify a knowledge base article to help her address. However, such a search may yield insufficient information for addressing the customer's issue. Using techniques and mechanisms described herein, Alexandra may be aided in generating a new knowledge base article, stored in the system as one or more text records, to aid customer service agents in future interactions with customers. Such a process may involve the automated retrieval of relevant text records and/or interaction records and the automated generation of recommended text to include in a new or updated text record. The new or updated text record may be configured in accordance with predetermined text record configuration information that identifies, for instance, one or more fields to include in the text record.

Text retrieval presents a significant technical challenge due to the unstructured nature of information stored as text. Text generation in the context of a live chat interaction presents additional technical challenges. First, a live chat interaction evolves over time, so text that is relevant earlier in the interaction may be different than text that is relevant later in the interaction. For example, the subject and tone of the interaction may change considerably as time progresses. Second, the live nature of the interaction means that text retrieval needs to be fast in order to be useful. Accordingly, improved techniques for rapidly identifying and accessing text based on relevance to other text help to address several significant technical challenges in information retrieval and novel text generation.

According to various embodiments, the term “text interaction” as used herein refers to any type of communication that can be treated as or converted to text. Such communications may include, but are not limited to: communications conducted via a live chat interface, a social media system, one or more emails, voice conversation, other types of communication, or a combination thereof. A text interaction is also referred to herein as a conversation.

According to various embodiments, text records representing conversations and being stored in a database system may be pre-processed to identify two or more information components. First, a text record may be preprocessed to identify a conversation topic for the conversation reflected in the text record. Second, a text record may be preprocessed to determine a text embedding of the conversation reflected in the text record based on sequential utterances. The text records may then be treated as values and indexed using at least these two components as keys. For instance, the components may be concatenated to produce the keys. As part of the preprocessing operations, a complete conversation may potentially be indexed multiple times, for instance by dividing it into partial sections of the whole conversation.

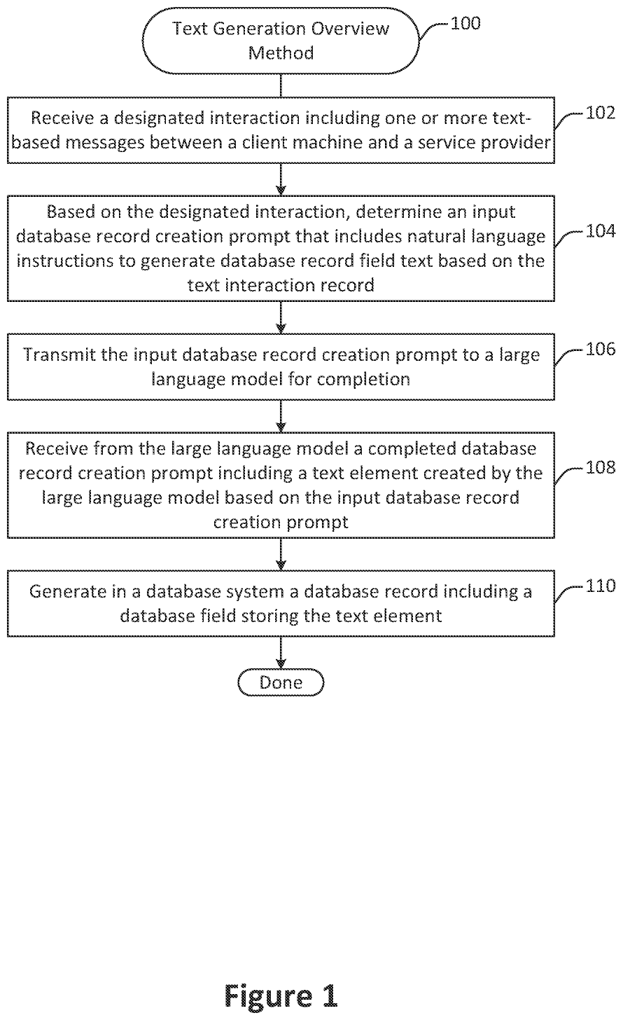

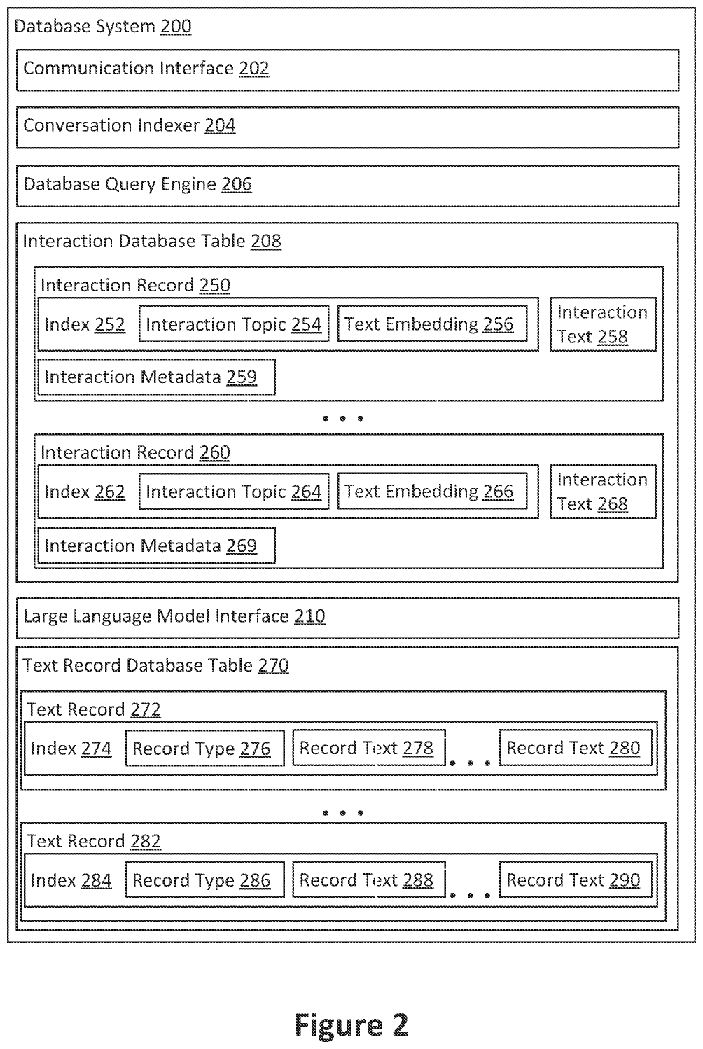

FIG. 1 illustrates an overview method 100 for generating text, performed in accordance with one or more embodiments. The method 100 may be performed at a database system such as the database system 200 shown in FIG. 2.

A designated interaction including one or more text-based messages between a client machine and a service provider is received at a database system at 102. In some embodiments, the designated interaction may be a conversation that takes place in the context of a live chat interaction. For instance, a customer service agent may interact with a customer at the client machine via a chat interface that includes a protocol for transmitting live chat messages via a network. Alternatively, the designated interaction may be a voice conversation that is converted to text, for instance via a text recognition process. As still another possibility, the designated interaction may be an email exchange or other asynchronous conversation.

In some embodiments, when the designated interaction is received, the system may display existing knowledge articles that are relevant to the issues discussed, for instance articles that may provide useful solutions, guidance, and/or other information. The human agent may then review the recommended knowledge articles and decide if any are useful for addressing the issues discussed in the conversation.

An input database record creation prompt is created based on the designated interaction at 104, for instance in the event that the existing knowledge articles are inadequate. According to various embodiments, the database record creation prompt may include natural language instructions to generate database record field text based on the text interaction record.

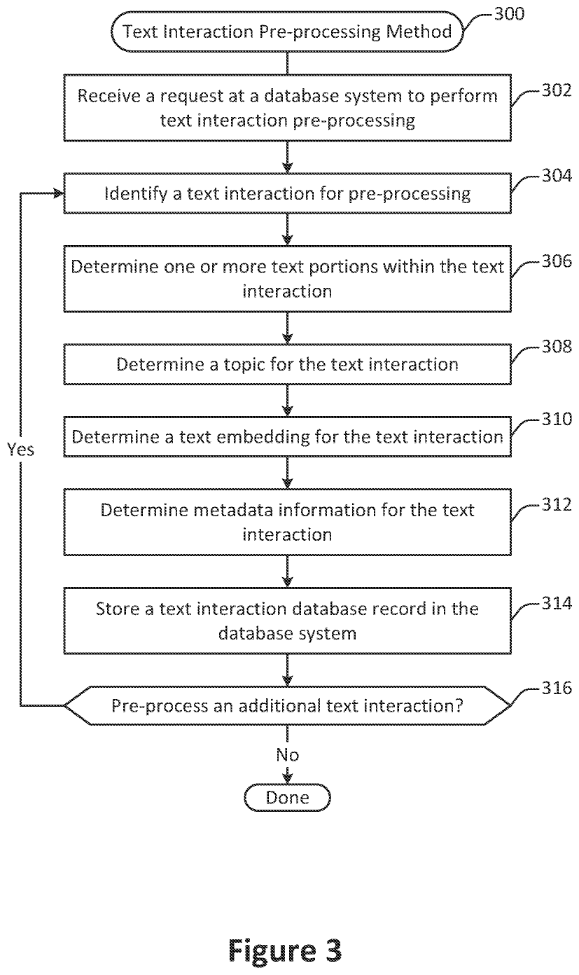

In some embodiments, creating an input database record creation prompt may involve identifying one or more reference interactions, for instance to provide additional context via additional customer service interactions. Existing knowledge articles and/or reference interactions may be preprocessed to determine text embeddings and/or conversation topics, which may then be used to query those knowledge articles and/or reference interactions. Additional information regarding such pre-processing operations is discussed with respect to the method 300 shown in FIG. 3.

To retrieve the existing knowledge articles and/or the one or more reference interactions, a designated text embedding including a designated vector representing the designated interaction in a multi-dimensional vector space may be determined. In some embodiments, the designated text embedding may be determined by a conversation embedding process. The conversation embedding process may extract information from conversation in a way that captures a sequence of back-and-forth utterances between two individuals.

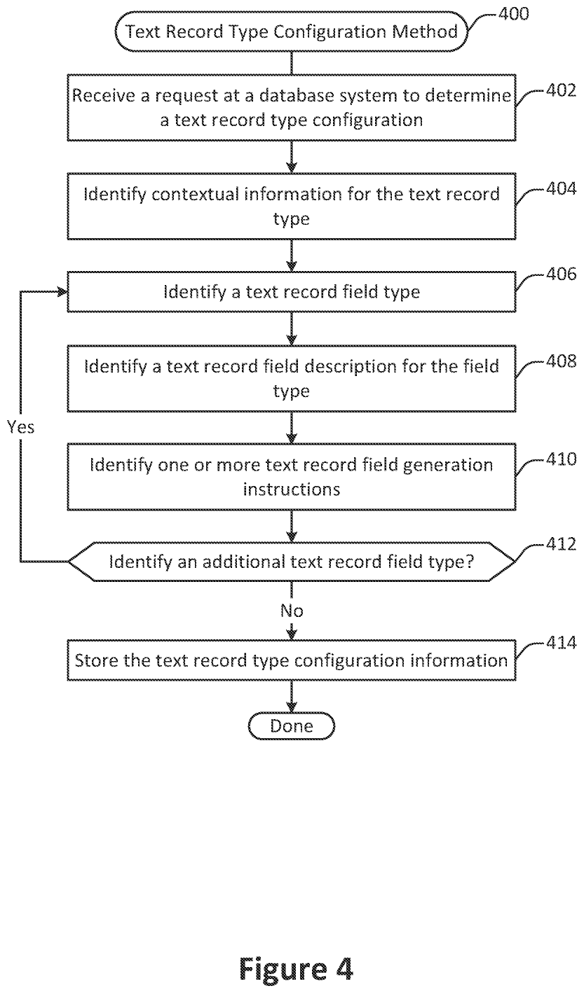

In some embodiments, in addition to the designated text embedding, one or more conversation topics may be identified. A conversation topic may include an overall subject, motivation, or purpose of the conversation or part of the conversation. In some configurations, the conversation topic may be encoded as a value, such as the identity of a cluster determined by performing clustering analysis on reference interactions stored in the database system. Alternatively, or additionally, the conversation topic may be encoded as a vector into a vector space representing topics. Additional information regarding the retrieval of text interactions and/or knowledge articles is discussed with respect to the method 400 shown in FIG. 4.

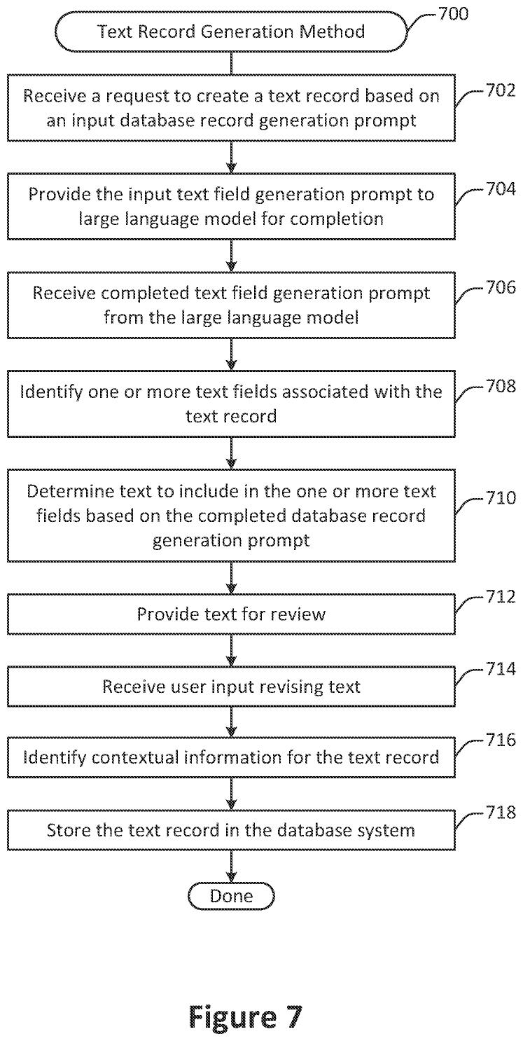

Returning to FIG. 1, the input database record creation prompt is transmitted to a large language model for completion at 106. A completed database record creation prompt including a text element created by the large language model based on the input database record creation prompt is received at 108. A database record including a database field storing the text element is generated at 110. Additional details regarding the generation of the text element and the creation of the database record are discussed with respect to the method 700 shown in FIG. 7.

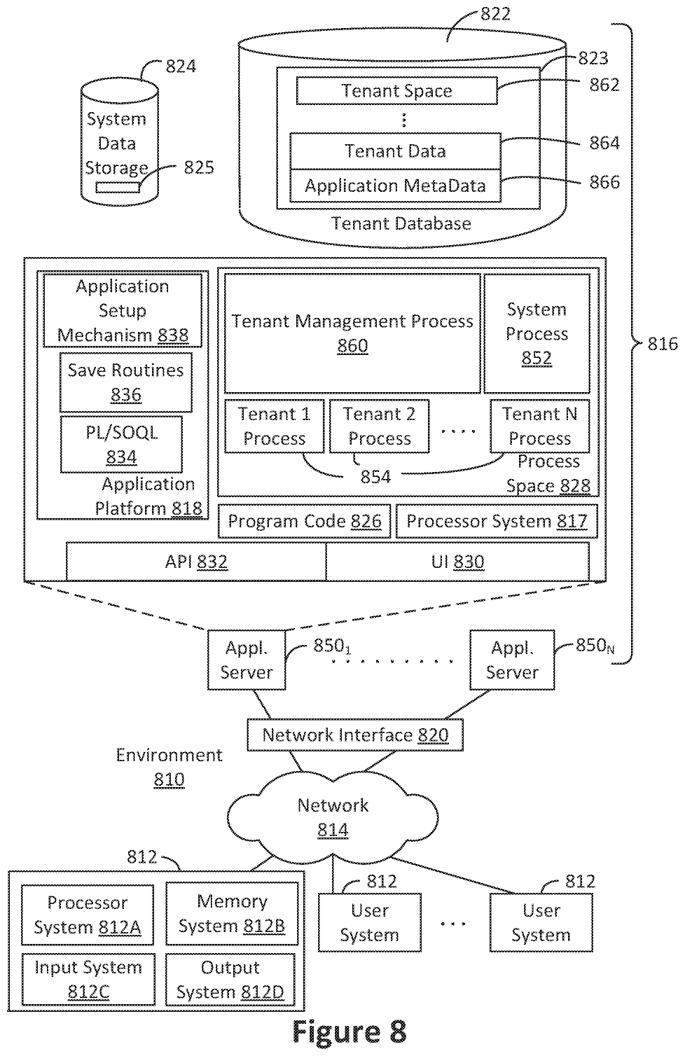

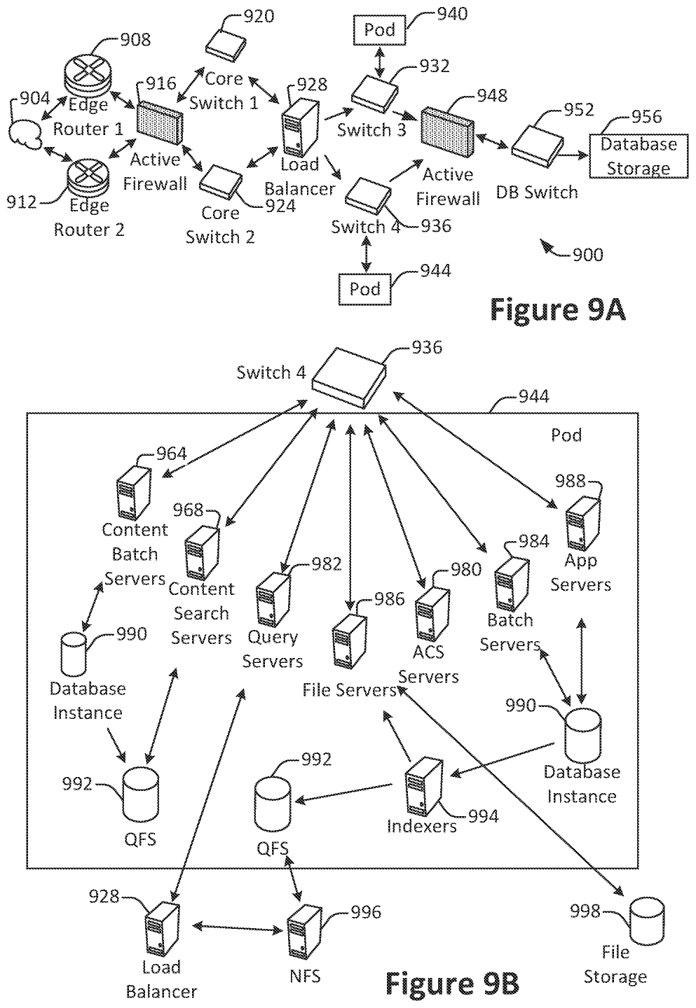

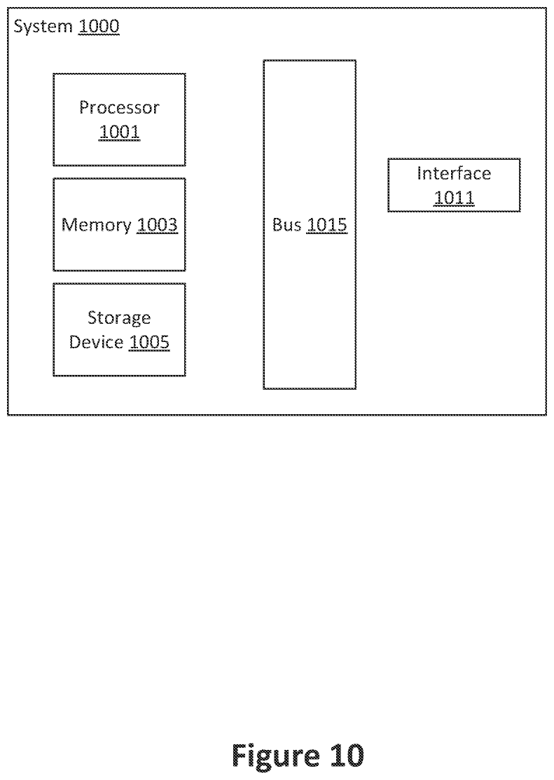

FIG. 2 illustrates a database system 200, configured in accordance with one or more embodiments. The database system 200 may perform one or more methods described herein. The database system 200 may be implemented in conjunction with one or more of the devices, components, and systems shown in FIG. 8, FIG. 9A, FIG. 9B, and FIG. 10.

The database system 200 includes a communication interface 202, a conversation indexer 204, a database query engine 206, an interaction database table 208, and a large language model interface 210. The interaction database table 208 includes one or more interaction database records such as the interaction database records 250 through 260. The interaction database record 250 includes an index 252, which includes an interaction topic 254 and a text embedding 256, and interaction text 258. Similarly, the interaction database record 260 includes an index 262, which includes an interaction topic 264 and a text embedding 266, and interaction text 268. Optionally, an interaction database record may include interaction metadata such as the metadata 259 and 269.

According to various embodiments, the communication interface 202 may be configured to communicate with other elements of an on-demand computing services environment in which the database system is situated. For instance, the communication interface 202 may be configured to communicate with an application server configured to support communications between a remote computing device and a service provider such as system operated by a human agent. Accordingly, the communication interface 202 may receive from the application server text information generated in the course of conducted such communications and transmit to the application server recommended text for use in such communications. Additional details regarding the generation of such text are discussed with respect to the method 400 shown in FIG. 4.

According to various embodiments, the conversation indexer 204 may be configured to receive text generated in the course of a communication session and then determine one or more indexes for that text. An index may be used to store the received text in the interaction database table 208. Alternatively, or additionally, the index may be used to retrieve similar text from the interaction database table 208. The interaction database table 208 may be accessed for data storage and/or retrieval via the database query engine 206.

In some implementations, the interaction database table 208 may be used to store one or more records for previous interactions. The interaction text 258 may store the text of a previous interaction, while the interaction index 252 may be used to search for and retrieve interactions based on a search query.

In some embodiments, an interaction index may include one or more elements. For instance, the interaction index 252 includes the interaction topic 254 that characterizes the interaction as a whole. The interaction index 252 also includes the text embedding 256 which provides more detailed and granular information about the sequence of utterances between the parties to the conversation.

In some embodiments, an interaction record may include metadata, such as the interaction metadata 259. The metadata 259 may allow the database query engine 206 to search the interaction records based on additional characteristics, such as the identity of the interaction participants, a date and/or time that the interaction occurred, performance evaluation information for the interaction, and/or other types of information.

In some implementations, the large language model interface 210 may be used to generate text based at least in part on information retrieved via the database query engine 206. For instance, interaction text associated with interaction records retrieved via the database query engine 206 may be provided to a large language model via the large language model interface 210 and used by the large language model interface 210 to generate novel text, such as a recommended reply to be used in an ongoing interaction.

In some embodiments, a large language model accessible via the large language model interface 210 may be located within the on-demand computing services environment in which the database system is located. Alternatively, a large language model accessible via the large language model interface 210 may be located remotely.

According to various embodiments, any of various large language models may be used. For instance, the large language model may be the ChatGPT model available from OpenAI, Google's Bard system, or any other suitable generative language model.

According to various embodiments, text records may be stored in the text record database table 270. For example, the text record database table 270 stores the text record 272 through the text record 282. The text records are associated with indexes 274 and 284 respectively.

In some implementations, a text record may be associated with at text record type, which may identify the types of information stored in the record text. For example, the text record 272 shown in FIG. 2 may be of a particular text record type as specified by the record type 276, with the text information stored in the record text 278 through 280 being configured in accordance to a data definition associated with the record type 276. Then, the text record 282 may be of a different text record type as specified by the record type 282, with the text information stored in the record text 288 through 290 being configured in accordance to a data definition associated with the record type 286. In this way, the record text 278 may store one type of text information, such as text associated with an “FAQ” field type, while the record text 288 may store a different type of text information, such as text associated with a “Resolution” field type.

In some embodiments, a text record may be associated with contextual information not illustrated in FIG. 2. For instance, a text record may be linked to a particular database tenant, knowledge base, or other such context. Additional details regarding such contextual information are discussed with respect to FIG. 4.

FIG. 3 illustrates a method 300 for pre-processing text interactions, performed in accordance with one or more embodiments. The method 300 may be performed at the database system 200 shown in FIG. 2. The method 300 may be performed in order to store one or more text interactions in the database system 200 for later search and retrieval, for instance for the purpose of generating new database records reflecting information in text interactions.

A request to perform text interaction pre-processing is received at a database system at 302. According to various embodiments, the request may be generated at any of various times. For example, the request may be generated when a new interaction is received by the database system, for instance immediately after it is conducted. As another example, the request may be generated periodically or at otherwise scheduled times. For instance, batches of interactions may be processed periodically, such as once per day.

A text interaction for pre-processing is identified at 304. The text interaction may be identified at the conversation indexer 204 shown in FIG. 2. According to various embodiments, the text interaction may characterize any type of communication between two or more parties. For example, the text interaction may reflect a conversation conducted via a live chat interface. As another example, the text interaction may reflect two or more emails, text messages, or social media messages sent via a text messaging interface. As yet another example, the text interaction may reflect a voice conversation converted to text via a voice-to-text processing system.

In some embodiments, the conversation indexer 204 may divide a single text interaction into two or more text interactions. For example, the system may impose a maximum length on a text interaction. As another example, the system may analyze a text interaction and determine that, for instance, the first part of the interaction relates to a first topic and a second part of the interaction relates to a second, different topic.

One or more text portions within the text are identified at 306. In some embodiments, dividing the text into portions may facilitate sequential analysis of the text. For instance, a text portion may be identified as a single utterance by an individual. An utterance may be one or more messages by the individual that are uninterrupted by text from other individuals. Thus, the text may be divided into a sequence of text portions corresponding with respective utterances by the individuals participating in the conversation.

A topic for the text interaction is determined at 308. According to various embodiments, the types of topics determined may depend in significant part on the types of conversations being analyzed. For example, the topic may identify a particular type of problem with a particular type of device purchased by a customer. As another example, the topic may identify a question about an aspect of a service arrangement. As another example, the topic may identify a request to return a particular type of device. As still another example, the topic may identify a request for technical assistance in a particular context.

In some embodiments, topic granularity may present a tradeoff. An increase in topic granularity may provide for more accurate conversation retrieval at the expense of having relatively fewer conversations for any particular topic.

According to various embodiments, topics may be determined in any of various ways. For example, the topic may be determined by applying an unsupervised clustering model to the text interaction to identify a single topic, which may be encoded as any distinct value capable of being stored in the database system. As another example, the topic may be determined by applying a word embedding model to represent the topic as a vector in a multi-dimensional vector space. As yet another example, the topic may be determined by applying an unsupervised topic model to identify one or more topics for the text interaction.

In some implementations, the topic may be identified via a large language model. For instance, a prompt including the interaction text and one or more natural instructions to identify the topic may be provided to a large language model. The large language model may then complete the prompt to provide the interaction topic. An example of a prompt template used to generate such a prompt is as follows. In the following prompt, “{conversation_context}” indicates a fillable portion that may be filled with some or all of the text from the conversation.

Identify the contact reason of the customer from the CONVERSATION section below.
The CONVERSATION section contains an ongoing conversation between a customer
and a service agent with multiple turns.
###
CONVERSATION:
{conversation_context}
###
Desired format:
{{
“contact_reason”:<identified contact reason from conversation above>
}}
What is the contact reason for the customer? If the contact reason is not yet
mentioned, then say “none”
Response JSON:

A text embedding is determined for the text interaction at 310. In some embodiments, the text embedding may be determined by applying a conversation embedder to the interaction text. The conversation embedder may determine a vector that represents the conversation text in a multi-dimensional vector space. In this way, the text interaction may be retrieved by searching for text interactions associated with a text embedding represented by a vector located in a similar area of the multi-dimensional vector space as a search vector.

In some embodiments, a conversation may include a sequence of utterances by different individuals. For instance, one or more sentences by a customer may be treated as a first utterance. Then, one or more sentences by a human agent provided in response may be treated as a second utterance. In such a configuration, the text included in an utterance may be generated by a single participant in a conversation.

In some embodiments, a conversation may be divided into sequential portions, with the text embedding being determined separately for different sequential portions. For example, the utterances in a conversation may be indexed sequentially. Then, the separate text embeddings may be determined for different portions.

In some embodiments, different text embeddings may be determined for the first five utterances, the first ten utterances, the first fifteen utterances, and so on. Alternatively, or additionally, different text embeddings may be determined for sequential intervals (e.g., 0-5, 5-10, 10-5) of utterances. In particular embodiments, a window may be applied so that a text embedding is limited to no more than a particular number (e.g., 20) of utterances. For instance, a text embedding may be determined for utterances 5-25. By dividing a conversation into sets of utterances, the conversation may be retrieved based on similarity of a first portion to search query for some first portion of the utterance.

In some embodiments, a text embedding configured for use in embedding a conversation may include various elements. For example, an utterance encoder Fᵤ may be used to map a single utterance to an embedding vector. The utterance encoder may be initialized with a bidirectional encoder representations from transforms (BERT) model. As another example, a document encoder F_{d} may be used to map a knowledge article to an embedding vector. The document encoder may also be initialized with a BERT model. As yet another example, an utterance importance function Fₐ may be used to map a single utterance embedding to an importance score. The utterance importance function may be implemented as a multilayer perceptron network, for instance with a single hidden layer of dimension 4*d, where d defines the dimensionality of the embedding vector. As still another example, a conversation embedding Fc may be used to map a full or partial conversation to a fixed-length vector. The conversation embedding may exhibit a functional form such as that shown in the following equation.

$${F}_{\text{?}} ( C ) := {\sum }_{u \text{?} C} {α}_{u} {F}_{\text{?}} ( u ) where {α}_{u} ∝ {F}_{\text{?}} ( {F}_{u} ( u ) ) and {\sum }_{u \text{?} C} {α}_{u} = 1$$

$$\text{?} \text{indicates text missing or illegible when filed}$$

The conversation embedding may not necessarily include any trainable parameters separate from the utterance importance function and the utterance encoder. The score of a conversation/article pair may be defined based on the following equation.

$$s ( C , A ) = 〈 {F}_{\text{?}} ( C ) , {F}_{d} ( A ) 〉 = 〈 {\sum }_{u ∈ C} {α}_{u} {F}_{u} ( u ) , {F}_{d} ( A ) 〉 = {\sum }_{u \text{?} C} {α}_{u} 〈 {F}_{u} ( u ) , {F}_{d} ( A ) 〉$$

$$\text{?} \text{indicates text missing or illegible when filed}$$

According to various embodiments, the conversation embedding described in the previous paragraph may be implemented as a network including attention and pre-trained sentence transformer models. The network may be initially fine-tuned, for instance to maximize retrieval scores for retrieving past conversations or knowledge articles related to example conversations in the training set. Then, when a new conversation context is received with different utterances in turn for a human agent and an individual at a remote computing device, a new conversation embedding may be obtained as follows. First, utterances may be separately embedded using a sentence embedder model (e.g., Fᵤ). Second, utterance attention scores may be determined for the utterances using a feed forward network (e.g., Fₐ). Third, conversational context embeddings may be determined as the weighted (by attention) average of the individual utterance embeddings.

Metadata information for the text interaction is determined at 312. In some embodiments, some or all of the metadata information may be provided by an application server responsible for facilitating the interaction. Alternatively, or additionally, some or all of the metadata may be determined based on analyzing the interaction text.

According to various embodiments, the metadata information may include any or all of a variety of types of information about the interaction. For example, metadata may identify one or more parties to the interaction. For instance, metadata may identify a customer, device, account, and/or human agent participating in the interaction. As another example, metadata information may include date and/or time information characterizing when the interaction occurred. As another example, metadata information may include performance data characterizing an evaluation of the interaction. The performance data may include, for instance, an indication as to whether the interaction was successful, an indication as to a customer review of the interaction, an indication as to whether a problem was successfully resolved, or the like. As still another example, metadata information may identify a tone associated with the conversation reflected by the interaction.

A text interaction database record is stored in the database system at 314. In some embodiments, the text interaction database record may include some or all of the information determined in the method 300. For instance, as shown in FIG. 2, a text interaction database record may include an index, interaction text, and optionally interaction metadata. The text interaction database record may be stored in the database by a database query engine.

In some embodiments, the text interaction database record may include an index determined based on the topic and/or the text embedding. For instance, the topic may be concatenated with the text embedding to determine the index. In this way, the text interaction database record may be retrievable via a search employing a search vector that includes a search topic and a search text embedding.

A determination is made at 316 as to whether to pre-process an additional text interaction. According to various embodiments, text interactions may be processed in parallel or in sequence, and in any suitable order. Furthermore, one or more operations shown in FIG. 3 may be performed in a different order than that shown. For instance, multiple text interaction database records may be stored to the database in a single query rather than separately.

FIG. 4 illustrates a method 400 for determining a text record type configuration, performed in accordance with one or more embodiments. The method 400 may be performed at the database system 200 shown in FIG. 2.

At 402, a request to determine a text record type configuration is received at the database system. The request may be generated based on user input. For instance, an administrator for a database tenant may provide a request to determine a text record type via user input provided via a graphical user interface.

Contextual information for the text record type is identified at 404. In some embodiments, the contextual information may include any suitable information characterizing the text record type. For example, the contextual information may include a name of the text record type. As another example, the contextual information may include identification information for a database tenant associated with the text record type. As yet another example, the contextual information may identify a context, such as a particular knowledge base or type of customer interaction, in which the text record type is applicable.

In some embodiments, contextual information may be determined based on user input. Alternatively, contextual information may be determined automatically. For instance, the method 400 may be implemented based on a request received from a user authenticated to an account associated with a particular database tenant. That tenant's identity may be automatically included in the contextual information. In this way, different tenants within a database system may be associated with different text records and different text record types.

A text record field type is identified at 406. In some embodiments, the text record field type may be selected from a list of predetermined text record field types. Some examples are as follows. An “Answer” field type may include a response or solution that resolves a specific question. An “Environment” field type may provide the context to a problem, such as a condition or configuration. An “Issue” field type may identify a customer's description of a problem. A “Problem” field type may identify a technical assessment of the issue. A “Process steps” field type may identify a series of actions taken to resolve the issue. A “Question” field type may identify a customer query. A “Resolution” field type may identify a solution to the problem. A “Root Cause” field type may identify a source or origin of the problem. A “Summary” field type may identify a synopsis of the conversation or issue. A “Troubleshooting Steps” field type may identify the series of actions taken to identify the problem and its root cause. A “Workaround” field type may identify a temporary solution to circumvent the issue or problem. One or more of these and/or other types of predetermined text record field types may be employed. Alternatively, or additionally, a custom text record field type may be created.

A text record field description may be determined for the field type at 408. According to various embodiments, the text record field description may serve as a textual explanation for the content of instances of the text record field type. A default text record field description may be associated with the text record field type. Alternatively, a custom text record field description may be determined, for instance based on user input.

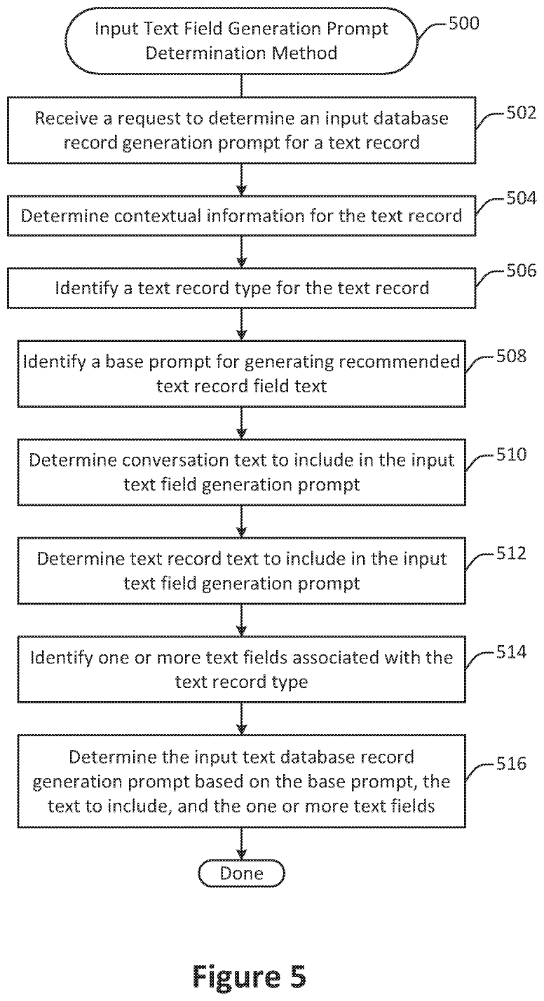

One or more text record field generation instructions are identified at 410. In some embodiments, the one or more text record field generation instructions may include natural language instructions executable by a large language model to generate recommended text for an instance of the text record field type. Examples of such instructions are provided below and discussed with respect to the method 500 shown in FIG. 5.

A determination is made at 412 as to whether to identify an additional text record field type. In some embodiments, the determination may be made based on user input. That is, a user may continue to add additional text record field types to a text record type until determining that additional text record field types are not needed. The user may then provide user input indicating that the text record type configuration information is to be stored.

The text record type configuration information is stored at 414. In some implementations, the text record type configuration information may be stored in a data dictionary associated with the database system. The data dictionary may store configuration information for custom database record types. In this way, different types of database records may be stored in the same database table according to dynamic schema information provided by the data dictionary. For instance, an entry in the data dictionary may identify a type of database record as well as types of information stored in fields within the database record. Such a configuration is discussed in additional details with respect to the text record database table 270 shown in FIG. 2. Alternatively, or additionally, the text record type configuration information may be stored in some other way.

FIG. 5 illustrates a method 500 for determining an input text field generation prompt, performed in accordance with one or more embodiments. The method 500 may be performed at a database system such as the database system 200 shown in FIG. 2

At 502, a request is received at a database system to determine an input database record generation prompt for generating a text record. In some embodiments, the request may be generated as discussed with respect to operation 104 shown in FIG. 1. That is, the request may be generated based on user input when a user determines that existing knowledge articles are insufficient for addressing an issue.

Context information for the text record is determined at 504. In some embodiments, context information may be automatically determined by the system. For instance, a service agent may be operating in association with a particular organization, database tenant, business line, product, geographic region, language, knowledge base, or other such context. Such information may then be linked with the text record created as discussed with respect to the method 500.

In some embodiments, context information may be determined based on user input. For instance, a service agent may manually select an organization, a database tenant, a business line, a product, a geographic region, a language, a knowledge base, or other such context for creating the text record.

A text record type is identified at 506. In some embodiments, the text record type may be selected from a set of predetermined text record types, such as “FAQ”, “how to”, or other such knowledge articles. Alternatively, the text record type may be dynamically configured, for instance as discussed with the method 400 shown in FIG. 4.

A base prompt for generating recommended text record field text is identified at 508. In some embodiments, the base prompt may be linked with the text record type when the text record type is configured. The same base prompt may be used with various types of text record types. Alternatively, different text record types may be associated with different base prompts.

Conversation text to include in the input text field generation prompt is determined at 510. In some embodiments, the conversation text may include a conversation being currently or recently conducted by a service agent responsible for requesting to create the text record as discussed at 502. For instance, the service agent may request to create the text record when existing knowledge articles fail to address an issue raised in the conversation.

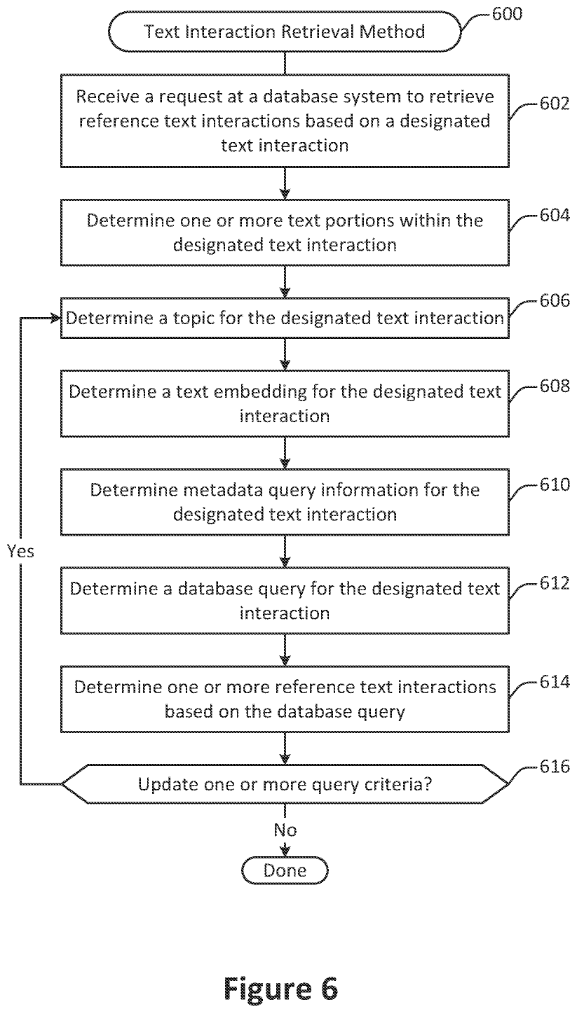

In some embodiments, the conversation text may optionally include one or more additional conversations retrieved based on the current conversation. For instance, the one or more additional conversations may be retrieved from the database system as discussed with respect to the method 600 shown in FIG. 6. The one or more additional conversations may be database records storing text from conversations conducted in the past that are related to similar issues, which may provide additional context for the large language model in generating the recommended text.

Text record text to include in the input text field generation prompt is optionally determined at 512. In some embodiments, the text record text may include text from existing knowledge articles that are related to the conversation text but that do not fully address the issues raised in the conversation. Such text records may be preprocessed and then retrieved in a manner similar to the pre-processing and retrieval of conversation text as discussed with respect to the methods 300 and 600 shown in FIG. 3 and FIG. 5. Such text records may provide additional context to the large language model when generating the recommended text, since they may be identified as text that is related but that does not fully address the issue. Accordingly, the large language model may use the text record text as a starting point for further refinement.

One or more text fields associated with the text record type are identified at 514. According to various embodiments, as discussed with respect to the method 400 shown in FIG. 4, a text record type may be associated with particular text record fields upon configuration. Such information may be used to modify the base prompt to create a prompt specific to the text record type.

The input database record generation prompt is determined at 516 based on the base prompt, the text to include, and the one or more text fields. In some embodiments, determining the input database record generation prompt may involve modifying the base prompt to include the text identified at operations 506 and 508. In addition, the base prompt may be modified to identify the text fields 514, for instance with identifiers tied to natural language instructions for generating recommended text corresponding with those text fields.

According to various embodiments, the base prompt may include natural language instructions that are executed by a large language model to generate recommended text for inclusion in the text record. The recommended text may correspond to the text fields identified at 514, and some of the natural language may be specific to particular text field types.

According to various embodiments, an example of a base prompt is provided below. However, various embodiments may employ various types of base prompts with various types of natural language instructions for generating text corresponding with text fields to include in a database record.
You are a knowledge base manager at a contact center. Your job is to draft a knowledge article based on only information in CONVERSATION provided below. The CONVERSATION below is between a service agent and a customer. The service agent is trying to resolve a customer issue. The generated article will be consumed by a customer service agent to address similar issues in future. The generated article has the following elements:

```
summary_{——}c
issue_{——}c
problem_{——}c
question_{——}c
answer_{——}c
troubleshooting_steps_{——}c
workaround_{——}c
root_cause_{——}c
resolution_{——}c
process_steps_{——}c
---
Provide output in JSON format with the following keys:
{{“summary_{——}c”: “Summary of the article”,
“issue_{——}c”: “Issue being addressed in the knowledge article”,
“problem_{——}c”: “Problem being addressed in the knowledge article”,
“question_{——}c”: {{“Question”: “Question in a FAQ article”,
“supporting_evidence”: “evidence from the CONVERSATION for the question”}},
“answer_{——}c”: {{“Answer”: “Answer to the Question mentioned in a FAQ article”,
“supporting_evidence”: “evidence from the CONVERSATION for the answer”}},
“troubleshooting_steps_{——}c”: [
  {{“step”: “First troubleshooting step to follow to resolve the issue or problem”,
  “supporting_evidence”: “Evidence for the first troubleshooting step”}},
  {{“step”: “Second troubleshooting step to follow to resolve the issue or
  problem”,
  “supporting_evidence”: “Evidence for the second troubleshooting step”}}],
“workaround_{——}c”: {{“workaround”: “Workaround for the issue or problem”,
“supporting_evidence”: “evidence from the CONVERSATION for the workaround”}},
“root_cause_{——}c”: {{“Root Cause”: “Root cause for the issue or problem”,
“supporting_evidence”: “evidence from the CONVERSATION for the Root cause”}},
“resolution_{——}c”: [
  {{“step”: “First step to follow”,
  “supporting_evidence”: “one evidence of the first step”}},
  {{“step”: “Second step to follow”,
  “supporting_evidence”: “one evidence of the second step”}}],
  “process_steps_{——}c”: [
  {{“step”: “First step to follow”,
  “supporting_evidence”: “one evidence of the first step”}},
  {{“step”: “Second step to follow”,
  “supporting_evidence”: “one evidence of the second step”}}]
  }}
---
```

Follow these instructions when creating the elements that make up the article:
Some instructions are element specific while other instructions apply to all elements.
1. Each generated article element should be complete on its own without referring to other generated elements.
2. Specific instructions for generating resolution_c:
   EXTRACT from CONVERSATION resolution provided by service agent to fix or conclude the customer issue.
   If the service agent didn't fix the issue at the end of the CONVERSATION, set “resolution_c” to “not specified”.
   DIVIDE resolution into steps. ASSIGN each step to “step” and “supporting_evidence” in each JSON in the list.
   If there is a help article URL mentioned in the resolution, include it in one of the steps.
3. Specific instructions for generating troubleshooting_steps_c:
   EXTRACT from CONVERSATION troubleshooting steps followed by service agent to resolve the customer issue.
   If there are no troubleshooting steps present in CONVERSATION then, set “troubleshooting_steps_c” to “not specified”.
   ASSIGN each step from extracted troubleshooting steps to “step” and “supporting_evidence” in each JSON in the list.
   If there is a help article URL mentioned in the extracted troubleshooting steps, include it in one of the steps.
4. Specific instructions for generating question_c, answer_c:
   Identify Question/Answer pair from CONVERSATION that is relevant to the Title of the article.
   In the Question/Answer pair, Question is usually asked by the customer.
   The Answer in answer__c should be self-contained and it should not refer to the contents of resolution_c or troubleshooting_steps_c.
   Write the identified Question/Answer pair in the style of a public Frequently Asked Questions (FAQ) document.
   If there is no appropriate Question/Answer Pair, then set Question to “none” and Answer to “none”
   If there is an article URL mentioned in the CONVERSATION, always include it in the Answer.
5. Specific Instructions for generating process_steps_c:
   Identify specific steps followed by agent or customer to achieve certain goals.
   Assign each step above to JSON field “step” and corresponding evidence from CONVERSATION to “supporting_evidence”.
   If no steps are identified, set “step” and “supporting_evidence” to “not specified”.
   Write in the style of a public how-to knowledge article.
6. Identify names mentioned in the CONVERSATION.
7. Ensure that those names are not included in the generated article content.
8. If a specific element cannot be identified from CONVERSATION and there is no supporting evidence
from CONVERSATION, set that element to ‘not specified’ in the output JSON. For example, if there is no supporting evidence for Root Cause mentioned in CONVERSATION, then set Root Cause to ‘not specified’ in the output.
---
CONVERSATION
{lct_utterrance}
---
All the elements in the generated article should have supporting evidence in CONVERSATION. Cite parts of utterances that support the sentences in the elements that are generated.

As shown above, the base prompt may include one or more fillable portions (e.g., “{lct_utterrance}”), that may be filled with text determined as discussed at operations 510 and 512. The base prompt may also include one or more references to other portions of the base prompt, such as “CONVERSATION” and “question_c”, which may identify the conversation text and a type of field for which to generate recommended text, respectively. The base prompt may also include natural language instructions, such as step “3” in the base prompt, instructing the large language model as to how to generate recommended text for particular text fields to be included in the database record.

FIG. 6 illustrates a method 600 for retrieving one or more text interactions, performed in accordance with one or more embodiments. The method 600 may be performed at a database system such as the database system 200 shown in FIG. 2.

At 602, a request is received at the database system to retrieve one or more reference text interactions based on a designated text interaction. According to various embodiments, the designated text interaction may be any communication that has been converted to text, and may represent communication between two or more entities. For instance, the designated text interaction may be a record of a live chat interaction, a voice call converted to text, a sequence of text messages or emails, or any other suitable representation of a conversation.

In some embodiments, the designated text interaction may be conducted via the database system itself. For instance, the designated text interaction may reflect a conversation between a customer service agent and a customer via a live chat interface provided via the database system. Alternatively, the designated text interaction may reflect a conversation conducted outside the database system. In such a configuration, the database system may be accessed via an interface for the purpose of storing text interactions and then generating recommended text based on the stored text interactions.

A topic is determined for the designated text interaction at 606, and a text embedding for the designated text interaction is determined at 608. In some embodiments, the topic and the text embedding may be determined in a manner similar to that discussed with respect to operations 308 and 310 shown in FIG. 3.

Metadata query information is optionally determined for the designated text interaction at 610. According to various embodiments, the metadata query information may include one or more of various types of criteria that may be used to refine the search for reference text interactions. A non-exhaustive list of examples of such criteria is provided below.

In some embodiments, metadata may be used to identify reference text interactions that have occurred within some window of time. For example, a metadata criterion may be used to retrieve reference text interactions for conversations that occurred within a particular time window, such as the most recent two-week period. As another example, reference text interactions may be used to prioritize more recent interactions over less recent interactions, for instance if the search returns different interactions of similar relevance but dating from different time periods. By prioritizing or selecting based on text record timing, records may be selected that are more likely to be relevant, for instance in the event that the text interactions reflect conversations related to a recently released product.

In some embodiments, metadata may be used to identify conversations within a target business unit and/or related to a target product or service. For instance, the designated text interaction may be associated with metadata characterizing a target business unit, product, or service to which the text interaction relates. Alternatively, or additionally, the interaction text in the text interaction may be analyzed to identify such a target business unit, product, or service. Such information may then be used to identify reference text interactions. Such search criteria may be used in any of a variety of situations, for instance when identifying reference conversations related to technical support of a product or service.

In some embodiments, metadata may be used to identify conversations with a particular participant or participants. For example, metadata may be used to prioritize the retrieval of conversations with the same customer and/or the same human agent as the designated conversation. As another example, metadata may be used to select or prioritize reference conversations involving human agents rated as highly skilled and/or highly performing. Such criteria may be used for a variety of purposes, such as ensuring that past interactions with the customer are reflected in recommended text, generating recommended text consistent with the human agent's personal communication style, and/or generating recommended text consistent with interactions considered of high quality by a service provider.

In some embodiments, default metadata information may be used. Alternatively, or additionally, one or more metadata criteria may be dynamically determined, for instance base on user input. In particular embodiments, as discussed with operation 616 below, metadata criteria may be iteratively refined to identify more relevant text interactions.

A database query is determined for the designated text interaction at 612. In some embodiments, the database query may include an index determined based on the topic and the text embedding, for instance by concatenating the topic with the text embedding. Additionally, the database query may optionally include one or more metadata query criteria determined as discussed with respect to the operation 610.

In some embodiments, the database query may treat a topic and text embedding portion separately. In this way, a database query may separately search and filter based on topic and (e.g., via a discrete requirement that the topic match) and text embedding (e.g., via a top k match criterion). Alternatively, a topic and/or text embedding may be separately weighted in a query, for instance if both facilitate searching based on relatively continuous similarity values.

In some embodiments, a query and/or text embedding may be weighted based on any of various criteria. For example, the system may weight or rank embeddings based on recency of terms, the presence of key terms (e.g. product names), or any other characteristics.

One or more reference text interactions are determined at 614 based on the database query. In some embodiments, the one or more reference text interactions may be determined by executing the database query against the interaction database table 208 using the database query engine 206 shown in FIG. 2.

In some implementations, executing the database query may involve identifying reference interaction database records having an index similar to the index determined for the database query. For instance, retrieved reference interactions having the same topic as included in the database query and a text embedding vector similar to that included in the database query may be identified. Similarity may be determined based on a distance measure computed in the multidimensional space. Examples of such distance metrics may include, but are not limited to: cosine distance, Euclidean distance, Minkowski distance, dot product distance, or any other suitable distance metric.

In some embodiments, the reference text interactions retrieved by the system may be selected and/or filtered. For instance, the system may select the top k text interactions in order of relevance for some value of k. The number of reference text interactions retrieved may be determined based on a configuration parameter. Alternatively, or additionally, the number of reference text interactions retrieved may be dynamically determined. For instance, a large language model may impose a word limit for prompts submitted to the large language model. This word limit may then restrict the number of reference text interactions that may be included in the prompt.

A determination is made at 616 as to whether to update one or more query criteria. In some embodiments, the determination may be made based on criteria such as a number and relevance of reference interactions retrieved by the database query. For instance, if a large number of database records are retrieved, then more restrictive metadata criteria may be used to further refine the quality and/or relevance of the text interactions retrieved. If instead a small number of database records are retrieved, and/or if the retrieved reference text interactions are below a designated relevance threshold, then one or more metadata criteria may be relaxed so as to retrieve additional relevant records.

FIG. 7 illustrates a method 700 for generating a text record, performed in accordance with one or more embodiments. The method 700 may be performed at a database system, such as the database system 200 shown in FIG. 2.

A request to create a text record based on an input database record generation prompt is received at 702. In some embodiments, the request may be received at the termination of the method 500 shown in FIG. 5.

The input database record generation prompt is provided to a large language model for completion at 704. A completed database record generation prompt is received from the large language model at 706. In some embodiments, the input database record generation prompt may be sent to the large language model and the completed database record generation prompt may be received from the large language model via the large language model interface 210 shown in FIG. 2.

One or more text fields associated with the text record are identified at 708. In some embodiments, the text fields may be the same as those identified as discussed with respect to the method 500 shown in FIG. 5.

Text to include in the one or more text fields is determined at 710 based on the completed text field generation prompt. According to various embodiments, identifying the text to include in the one or more text fields may involve, for instance, extracting the text from a structured portion of the completed text field generation prompt. For instance, as discussed with respect to the method 500 shown in FIG. 5, the input text generation prompt may include a portion to be completed by the large language model along with instructions for how to structure the generated text (e.g., JSON format) to facilitate extraction.

The text is provided for review at 712. In some embodiments, providing the text for review may involve transmitting the text to a remote computing device, for instance a device associated with the service agent, for presentation in a user interface at the remote computing device.

User input revising the text is optionally received at 714. In some embodiments, the service agent or another user may review the text for applicability, accuracy, and/or other such criteria, and may provide user input revising the text.

Contextual information for the text record is identified at 716. In some embodiments, the contextual information may be the same as that determined as discussed with respect to the method 500 shown in FIG. 5.

The text record is stored in the database system at 718. The text record stored in the database system may include the contextual information identified at 716 as well as the text determined at 710 and revised at 714.

FIG. 8 shows a block diagram of an example of an environment 810 that includes an on-demand database service configured in accordance with some implementations. Environment 810 may include user systems 812, network 814, database system 816, processor system 817, application platform 818, network interface 820, tenant data storage 822, tenant data 823, system data storage 824, system data 825, program code 826, process space 828, User Interface (UI) 830, Application Program Interface (API) 832, PL/SOQL 834, save routines 836, application setup mechanism 838, application servers 850-1 through 850-N, system process space 852, tenant process spaces 854, tenant management process space 860, tenant storage space 862, user storage 864, and application metadata 866. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 816, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 818 may be a framework that allows the creation, management, and execution of applications in system 816. Such applications may be developed by the database service provider or by users or third-party application developers accessing the service. Application platform 818 includes an application setup mechanism 838 that supports application developers' creation and management of applications, which may be saved as metadata into tenant data storage 822 by save routines 836 for execution by subscribers as one or more tenant process spaces 854 managed by tenant management process 860 for example. Invocations to such applications may be coded using PL/SOQL 834 that provides a programming language style interface extension to API 832. A detailed description of some PL/SOQL language implementations is discussed in commonly assigned U.S. Pat. No. 9,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 866 for a subscriber making such an invocation. Such system processes may also manage execution of application metadata 866 as an application in a virtual machine.

In some implementations, each application server 850 may handle requests for any user associated with any organization. A load balancing function (e.g., an F5 Big-IP load balancer) may distribute requests to the application servers 850 based on an algorithm such as least-connections, round robin, observed response time, etc. Each application server 850 may be configured to communicate with tenant data storage 822 and the tenant data 823 therein, and system data storage 824 and the system data 825 therein to serve requests of user systems 812. The tenant data 823 may be divided into individual tenant storage spaces 862, which can be either a physical arrangement and/or a logical arrangement of data. Within each tenant storage space 862, user storage 864 and application metadata 866 may be similarly allocated for each user. For example, a copy of a user's most recently used (MRU) items might be stored to user storage 864. Similarly, a copy of MRU items for an entire tenant organization may be stored to tenant storage space 862. A UI 830 provides a user interface and an API 832 provides an application programming interface to system 816 resident processes to users and/or developers at user systems 812.

System 816 may implement a web-based text retrieval and generation system. For example, in some implementations, system 816 may include application servers configured to implement and execute text retrieval and generation software applications. The application servers may be configured to provide related data, code, forms, web pages and other information to and from user systems 812. Additionally, the application servers may be configured to store information to, and retrieve information from a database system. Such information may include related data, objects, and/or Webpage content. With a multi-tenant system, data for multiple tenants may be stored in the same physical database object in tenant data storage 822, however, tenant data may be arranged in the storage medium(s) of tenant data storage 822 so that data of one tenant is kept logically separate from that of other tenants. In such a scheme, one tenant may not access another tenant's data, unless such data is expressly shared.

Several elements in the system shown in FIG. 8 include conventional, well-known elements that are explained only briefly here. For example, user system 812 may include processor system 812A, memory system 812B, input system 812C, and output system 812D. A user system 812 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 812 to access, process and view information, pages and applications available from system 816 over network 814. Network 814 may be any network or combination of networks of devices that communicate with one another, such as any one or any combination of a LAN (local area network), WAN (wide area network), wireless network, or other appropriate configuration.

The users of user systems 812 may differ in their respective capacities, and the capacity of a particular user system 812 to access information may be determined at least in part by “permissions” of the particular user system 812. As discussed herein, permissions generally govern access to computing resources such as data objects, components, and other entities of a computing system, such as a text retrieval and generation system, a social networking system, and/or a CRM database system. “Permission sets” generally refer to groups of permissions that may be assigned to users of such a computing environment. For instance, the assignments of users and permission sets may be stored in one or more databases of System 816. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 816 may provide on-demand database service to user systems 812 using an MTS arrangement. By way of example, one tenant organization may be a company that employs a sales force where each salesperson uses system 816 to manage their sales process. Thus, a user in such an organization may maintain contact data, leads data, customer follow-up data, performance data, goals and progress data, etc., all applicable to that user's personal sales process (e.g., in tenant data storage 822). In this arrangement, a user may manage his or her sales efforts and cycles from a variety of devices, since relevant data and applications to interact with (e.g., access, view, modify, report, transmit, calculate, etc.) such data may be maintained and accessed by any user system 812 having network access.

When implemented in an MTS arrangement, system 816 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 816 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 816 may also maintain system-level data usable by multiple tenants or other data. Such system-level data may include industry reports, news, postings, and the like that are sharable between tenant organizations.

In some implementations, user systems 812 may be client systems communicating with application servers 850 to request and update system-level and tenant-level data from system 816. By way of example, user systems 812 may send one or more queries requesting data of a database maintained in tenant data storage 822 and/or system data storage 824. An application server 850 of system 816 may automatically generate one or more SQL statements (e.g., one or more SQL queries) that are designed to access the requested data. System data storage 824 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For text retrieval and generation applications, such standard entities may include interaction records representing conversations and indexed based on information such as conversation topic and conversation embeddings. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 9,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

FIG. 9A shows a system diagram of an example of architectural components of an on-demand database service environment 900, configured in accordance with some implementations. A client machine located in the cloud 904 may communicate with the on-demand database service environment via one or more edge routers 908 and 912. A client machine may include any of the examples of user systems 812 described above. The edge routers 908 and 912 may communicate with one or more core switches 920 and 924 via firewall 916. The core switches may communicate with a load balancer 928, which may distribute server load over different pods, such as the pods 940 and 944 by communication via pod switches 932 and 936. The pods 940 and 944, which may each include one or more servers and/or other computing resources, may perform data processing and other operations used to provide on-demand services. Components of the environment may communicate with a database storage 956 via a database firewall 948 and a database switch 952.

Accessing an on-demand database service environment may involve communications transmitted among a variety of different components. The environment 900 is a simplified representation of an actual on-demand database service environment. For example, some implementations of an on-demand database service environment may include anywhere from one-to-many devices of each type. Additionally, an on-demand database service environment need not include each device shown, or may include additional devices not shown, in FIGS. 9A and 9B.

The cloud 904 refers to any suitable data network or combination of data networks, which may include the Internet. Client machines located in the cloud 904 may communicate with the on-demand database service environment 900 to access services provided by the on-demand database service environment 900. By way of example, client machines may access the on-demand database service environment 900 to retrieve, store, edit, and/or process text retrieval and generation information.

In some implementations, the edge routers 908 and 912 route packets between the cloud 904 and other components of the on-demand database service environment 900. The edge routers 908 and 912 may employ the Border Gateway Protocol (BGP). The edge routers 908 and 912 may maintain a table of IP networks or ‘prefixes’, which designate network reachability among autonomous systems on the internet.

In one or more implementations, the firewall 916 may protect the inner components of the environment 900 from internet traffic. The firewall 916 may block, permit, or deny access to the inner components of the on-demand database service environment 900 based upon a set of rules and/or other criteria. The firewall 916 may act as one or more of a packet filter, an application gateway, a stateful filter, a proxy server, or any other type of firewall.

In some implementations, the core switches 920 and 924 may be high-capacity switches that transfer packets within the environment 900. The core switches 920 and 924 may be configured as network bridges that quickly route data between different components within the on-demand database service environment. The use of two or more core switches 920 and 924 may provide redundancy and/or reduced latency.

In some implementations, communication between the pods 940 and 944 may be conducted via the pod switches 932 and 936. The pod switches 932 and 936 may facilitate communication between the pods 940 and 944 and client machines, for example via core switches 920 and 924. Also or alternatively, the pod switches 932 and 936 may facilitate communication between the pods 940 and 944 and the database storage 956. The load balancer 928 may distribute workload between the pods, which may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948, which may act as a computer application firewall operating at the database application layer of a protocol stack. The database firewall 948 may protect the database storage 956 from application attacks such as structure query language (SQL) injection, database rootkits, and unauthorized information disclosure. The database firewall 948 may include a host using one or more forms of reverse proxy services to proxy traffic before passing it to a gateway router and/or may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, the database storage 956 may be an on-demand database system shared by many different organizations. The on-demand database service may employ a single-tenant approach, a multi-tenant approach, a virtualized approach, or any other type of database approach. Communication with the database storage 956 may be conducted via the database switch 952. The database storage 956 may include various software components for handling database queries. Accordingly, the database switch 952 may direct database queries transmitted by other components of the environment (e.g., the pods 940 and 944) to the correct components within the database storage 956.

FIG. 9B shows a system diagram further illustrating an example of architectural components of an on-demand database service environment, in accordance with some implementations. The pod 944 may be used to render services to user(s) of the on-demand database service environment 900. The pod 944 may include one or more content batch servers 964, content search servers 968, query servers 982, file servers 986, access control system (ACS) servers 980, batch servers 984, and app servers 988. Also, the pod 944 may include database instances 990, quick file systems (QFS) 992, and indexers 994. Some or all communication between the servers in the pod 944 may be transmitted via the switch 936.

In some implementations, the app servers 988 may include a framework dedicated to the execution of procedures (e.g., programs, routines, scripts) for supporting the construction of applications provided by the on-demand database service environment 900 via the pod 944. One or more instances of the app server 988 may be configured to execute all or a portion of the operations of the services described herein.

In some implementations, as discussed above, the pod 944 may include one or more database instances 990. A database instance 990 may be configured as an MTS in which different organizations share access to the same database, using the techniques described above. Database information may be transmitted to the indexer 994, which may provide an index of information available in the database 990 to file servers 986. The QFS 992 or other suitable filesystem may serve as a rapid-access file system for storing and accessing information available within the pod 944. The QFS 992 may support volume management capabilities, allowing many disks to be grouped together into a file system. The QFS 992 may communicate with the database instances 990, content search servers 968 and/or indexers 994 to identify, retrieve, move, and/or update data stored in the network file systems (NFS) 996 and/or other storage systems.

In some implementations, one or more query servers 982 may communicate with the NFS 996 to retrieve and/or update information stored outside of the pod 944. The NFS 996 may allow servers located in the pod 944 to access information over a network in a manner similar to how local storage is accessed. Queries from the query servers 922 may be transmitted to the NFS 996 via the load balancer 928, which may distribute resource requests over various resources available in the on-demand database service environment 900. The NFS 996 may also communicate with the QFS 992 to update the information stored on the NFS 996 and/or to provide information to the QFS 992 for use by servers located within the pod 944.

In some implementations, the content batch servers 964 may handle requests internal to the pod 944. These requests may be long-running and/or not tied to a particular customer, such as requests related to log mining, cleanup work, and maintenance tasks. The content search servers 968 may provide query and indexer functions such as functions allowing users to search through content stored in the on-demand database service environment 900. The file servers 986 may manage requests for information stored in the file storage 998, which may store information such as documents, images, basic large objects (BLOBs), etc. The query servers 982 may be used to retrieve information from one or more file systems. For example, the query system 982 may receive requests for information from the app servers 988 and then transmit information queries to the NFS 996 located outside the pod 944. The ACS servers 980 may control access to data, hardware resources, or software resources called upon to render services provided by the pod 944. The batch servers 984 may process batch jobs, which are used to run tasks at specified times. Thus, the batch servers 984 may transmit instructions to other servers, such as the app servers 988, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

FIG. 10 illustrates one example of a computing device. According to various embodiments, a system 1000 suitable for implementing embodiments described herein includes a processor 1001, a memory module 1003, a storage device 1005, an interface 1011, and a bus 1015 (e.g., a PCI bus or other interconnection fabric.) System 1000 may operate as variety of devices such as an application server, a database server, or any other device or service described herein. Although a particular configuration is described, a variety of alternative configurations are possible. The processor 1001 may perform operations such as those described herein. Instructions for performing such operations may be embodied in the memory 1003, on one or more non-transitory computer readable media, or on some other storage device. Various specially configured devices can also be used in place of or in addition to the processor 1001. The interface 1011 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of live chat interfaces. However, the techniques disclosed herein apply to a wide variety of interaction contexts, such as email-based interactions, text-message-based interactions, voice-based interactions, and the like. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
receiving a text interaction record at a database system, the text interaction record including interaction text from one or more messages between a client machine and a service provider;
determining an input database record creation prompt that includes natural language instructions to generate database record field text based on the text interaction record, the input database record creation prompt including some or all of the interaction text;
transmitting the input database record creation prompt to a large language model for completion;
receiving a completed database record creation prompt from the large language model, the completed database record creation prompt including a text element created by the large language model based on the input database record creation prompt;
generating a database record in the database system, the database record including a database field storing the text element;
determining a text interaction topic based on the interaction text;
determining a text embedding representing the interaction text in a multi-dimensional vector space;
determining a database query including an index based on the text interaction topic and the text embedding; and
executing the database query to obtain a result.

2. The method recited in claim 1, wherein the input database record creation prompt includes a plurality of identifiers corresponding with a plurality of text fields to include in the database record.

3. The method recited in claim 2, wherein the input database record creation prompt includes a plurality of sets of natural language instructions to generate text corresponding with the plurality of text fields.

4. The method recited in claim 1, wherein determining the input database record creation prompt comprises combining a base prompt with the interaction text, the base prompt including a fillable portion that is replaced with the interaction text.

5. The method recited in claim 1, wherein the one or more messages are text-based messages transmitted in a live chat session.

6. The method recited in claim 1, wherein the one or more messages are voice-based messages, and wherein the interaction text is determined by converting the one or more messages to text.

7. The method recited in claim 1, the method further comprising:
determining a search vector based on the interaction text via a processor at the database system, the search vector including a text embedding representing the interaction text in a multi-dimensional vector space.

8. The method recited in claim 7, the method further comprising:
retrieving a reference interaction record from the database system based on the search vector, the reference interaction record including reference interaction text, the reference interaction record including a reference vector representing the reference interaction text in the multi-dimensional vector space, and wherein the input database record creation prompt includes some or all of the reference interaction text.

9. The method recited in claim 8, wherein the text embedding is determined via a text embedding model trained using a plurality of training data interactions including the reference interaction record.

10. The method recited in claim 7, the method further comprising:
determining a text interaction topic based on the interaction text, wherein the search vector also includes the text interaction topic.

11. The method recited in claim 10, wherein the text interaction topic is determined by applying the large language model to some or all of the interaction text.

12. The method recited in claim 10, wherein the text interaction topic is determined by applying a topic model to some or all of the interaction text.

13. Non-transitory computer readable media having instructions stored thereon for performing a method, the method comprising:
receiving a text interaction record at a database system, the text interaction record including interaction text from one or more messages between a client machine and a service provider;
determining an input database record creation prompt that includes natural language instructions to generate database record field text based on the text interaction record, the input database record creation prompt including some or all of the interaction text;
transmitting the input database record creation prompt to a large language model for completion;
receiving a completed database record creation prompt from the large language model, the completed database record creation prompt including a text element created by the large language model based on the input database record creation prompt;
generating a database record in the database system, the database record including a database field storing the text element;
determining a text interaction topic based on the interaction text;
determining a text embedding representing the interaction text in a multi-dimensional vector space;
determining a database query including an index based on the text interaction topic and the text embedding; and
executing the database query to obtain a result.

14. The non-transitory computer readable media recited in claim 13, wherein the input database record creation prompt includes a plurality of identifiers corresponding with a plurality of text fields to include in the database record, and wherein the input database record creation prompt includes a plurality of sets of natural language instructions to generate text corresponding with the plurality of text fields.

15. The non-transitory computer readable media recited in claim 13, wherein determining the input database record creation prompt comprises combining a base prompt with the interaction text, the base prompt including a fillable portion that is replaced with the interaction text.

16. The non-transitory computer readable media recited in claim 13, the method further comprising:
determining a search vector based on the interaction text via a processor at the database system, the search vector including a text embedding representing the interaction text in a multi-dimensional vector space; and
retrieving a reference interaction record from the database system based on the search vector, the reference interaction record including reference interaction text, the reference interaction record including a reference vector representing the reference interaction text in the multi-dimensional vector space, and wherein the input database record creation prompt includes some or all of the reference interaction text.

17. The non-transitory computer readable media recited in claim 16, the method further comprising:
determining a text interaction topic based on the interaction text, wherein the search vector also includes the text interaction topic, wherein the text interaction topic is determined by applying a topic model to some or all of the interaction text, the topic model being trained using a plurality of training data interaction records including the reference interaction record.

18. A database system comprising:
a communication interface configured to receive a text interaction record including interaction text from one or more messages between a client machine and a service provider; a processor configured to determine an input database record creation prompt that includes natural language instructions to generate database record field text based on the text interaction record, the input database record creation prompt including some or all of the interaction text;
a large language model interface configured to transmit the input database record creation prompt to a large language model for completion and to receive a completed database record creation prompt from the large language model, the completed database record creation prompt including a text element created by the large language model based on the input database record creation prompt; and
a database query engine configured to; generate a database record including a database field storing the text element, determine a text interaction topic based on the interaction text, determine a text embedding representing the interaction text in a multi-dimensional vector space, determine a database query including an index based on the text interaction topic and the text embedding, and execute the database query to obtain a result.

19. The database system recited in claim 18, wherein the input database record creation prompt includes a plurality of identifiers corresponding with a plurality of text fields to include in the database record, and wherein the input database record creation prompt includes a plurality of sets of natural language instructions to generate text corresponding with the plurality of text fields.

20. The database system recited in claim 18, wherein determining the input database record creation prompt comprises combining a base prompt with the interaction text, the base prompt including a fillable portion that is replaced with the interaction text.
